(19) United States
(12) Patent Application Publication
(10) Pub. No.: US 2016/0292610 A1
(43) Pub. Date: Oct. 6, 2016

(54) METHOD AND DEVICE FOR REAL TIME PREDICTION OF TIMELY DELIVERY OF TELECOM SERVICE ORDERS

(71) Applicants: Sandeep Ashok Sapre, Pune (IN); Abhay Tiku, New Delhi (IN); Shalabh Srivastava, Greater Noida (IN); Amit Akshay Kumar Kale, Pune (IN)

(72) Inventors: Sandeep Ashok Sapre, Pune (IN); Abhay Tiku, New Delhi (IN); Shalabh Srivastava, Greater Noida (IN); Amit Akshay Kumar Kale, Pune (IN)

(73) Assignee: Wipro Limited, Bangalore (IN)

(21) Appl. No.: 14/754,602

(22) Filed: Jun. 29, 2015

(30) Foreign Application Priority Data
Mar. 30, 2015 (IN) 1616/CHE/2015

(51) Int. Cl. G06Q 10/06; G06N 5/04

(52) U.S. Cl. CPC G06Q 10/06375; G06Q 10/067; G06N 5/04

(57) ABSTRACT

The present disclosure relates to a method and a prediction device for predicting timely delivery of telecom service orders in real time. In one embodiment, the method receives order data of historical time period and processes the order data to derive one or more variables and add missing values in the order data. Based on the processed order data, one or more models are generated and a model having least model generation error rate is identified. Using the model thus identified, prediction of timely delivery of telecom services is predicted in real time using real time data. By way of identifying factors that influence the timely delivery in each stage, helps to improve the probability of timely delivery by correcting the identified factors, thus improving customer experience and revenue realization to the telecom service providers.

### PRIORITY CLAIM

This U.S. patent application claims priority under 35 U.S.C. §119 to: Indian Application No. 1616/CHE/2015, filed on Mar. 30, 2015. The aforementioned application is incorporated herein by reference in its entirety.

### FIELD OF THE DISCLOSURE

The present subject matter is related, in general to predictive modeling, and more particularly, but not exclusively to method and device for predicting timely delivery of telecom service orders in real time.

### BACKGROUND

Typically delivery of telecom products to customers varies in time depending on the type of product to be delivered. Telecom service providers generally fail to deliver the product on time that causes negative experience in customer minds resulting in customer dissatisfaction and delay in revenue realization or some time may lead to loss of revenue to the service providers. Conventional systems fail to identify the factors that influence the timely delivery of telecom products at various stages in real time. Therefore, there is a need to provide a method and a device for predicting timely delivery of telecom service orders in real time.

### SUMMARY OF THE DISCLOSURE

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of predicting timely delivery of telecom service orders in real time. The method comprises the step of receiving order data collected for a predetermined time period from a telecom service provider repository. The order data comprises data corresponding to one or more first variables associated with a plurality of telecom service orders. The method further comprises processing the received order data to generate a processed order data comprising one or more second variables and one or more missing data corresponding to the first variables derived from the received order data. Upon processing the order data, a plurality of models based on one or more first and second variables identified from the processed order data is generated and a model having a minimum model generation error rate among the plurality of models is selected. Based on the selected model and real time order data, the timely delivery of the telecom services is predicted.

Further, the present disclosure relates to a prediction device for predicting timely delivery of telecom service orders in real time. The system comprises a processor and a telecom service provider repository coupled with the processor and configured to store order data associated with a plurality of telecom service orders. The system further comprises a memory communicatively coupled to the processor, wherein the memory stores processor-executable instructions, which, on execution, cause the processor to receive the order data collected for a predetermined time period from the telecom service providers repository. The processor is further configured to process the received order data to generate a processed order data comprising one or more second variables and one or more missing data corresponding to the first variables derived from the received order data. The processor is furthermore configured to generate a plurality of models based on one or more first and second variables identified from the processed order data and select a model having a minimum model generation error rate among the plurality of models thus generated. The processor predicts the timely delivery of the telecom services based on the selected model and real time order data.

Furthermore, the present disclosure relates to a non-transitory computer readable medium including instructions stored thereon that when processed by at least one processor cause a system to perform the act of receiving order data related to a predetermined time period comprising one or more first variables associated with a plurality of telecom service orders. Further, the instructions cause the processor to perform the acts of processing the received order data to generate a processed order data comprising one or more second variables and one or more missing data corresponding to the first variables derived from the received order data. Furthermore, the instructions cause the processor to perform the acts of generating a plurality of models based on one or more first and second variables identified from the processed order data and selecting a model having a minimum model generation error rate among the plurality of models thus generated. Upon selecting the model, the instructions cause the processor to perform the act of predicting the timely delivery of the telecom services based on the selected model and real time order data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for predicting timely delivery of telecom service orders in real time in accordance with some embodiments of the present disclosure;

FIG. 2 illustrates a block diagram of a prediction device for predicting timely delivery of telecom service orders in real time in accordance with some embodiments of the present disclosure;

FIG. 3 illustrates a flowchart of a method of predicting timely delivery of telecom service orders in real time in accordance with some embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a prediction device for predicting timely delivery of telecom service orders in real time. In one embodiment, the method receives order data of historical time period and processes the order data to derive one or more variables and add missing values in the order data. Based on the processed order data, one or more models are generated and a model having least model generation error rate is identified. Using the model thus identified, prediction of timely delivery of telecom services is predicted in real time using real time data. By way of identifying factors that influences the timely delivery in each stage helps to improve the probability of timely delivery by correcting the identified factors, thus improving customer experience and revenue realization to the telecom service providers.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

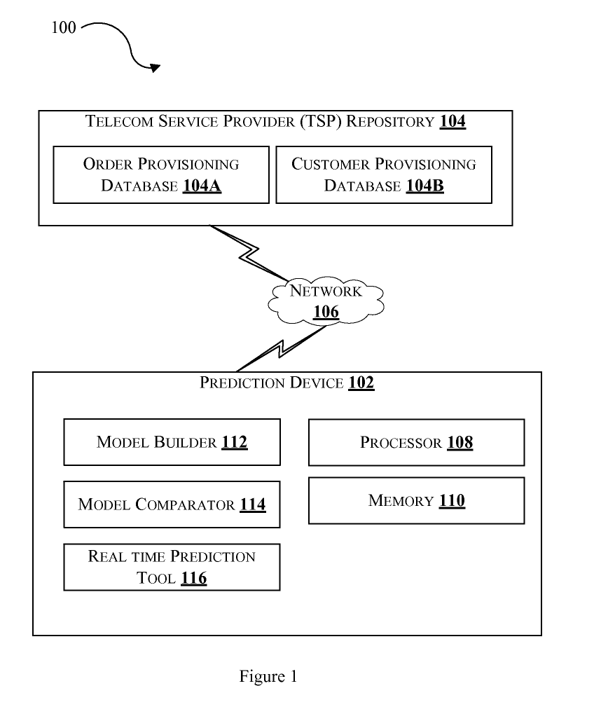

FIG. 1 illustrates architecture of system 100 for predicting timely delivery of telecom service orders in real time in accordance with some embodiments of the present disclosure.

As shown in FIG. 1, the system 100 comprises one or more components coupled with each other. In one implementation, the system 100 comprises a prediction device 102 communicatively coupled with a Telecom Service Provider (TSP) repository 104 via a communication network 106. The TSP repository 104 comprises at least an order provisioning database 104A and a customer provisioning database 104B. The order provisioning database 104A stores data associated with orders including customer details like customer address, date of service, billing details and product details and so on. The customer provisioning database 104B stores data associated with customer including customer requirements of products, customer order placed date and order requested date. In one embodiment, data from the customer provisioning database 104B is consolidated with the order provisioning database 104A for prediction of timely delivery of customer orders. The prediction device 102 receives the consolidated order data from the TSP repository 104 and determines a model that predicts in real time the timely delivery of telecom products based on the consolidate order data.

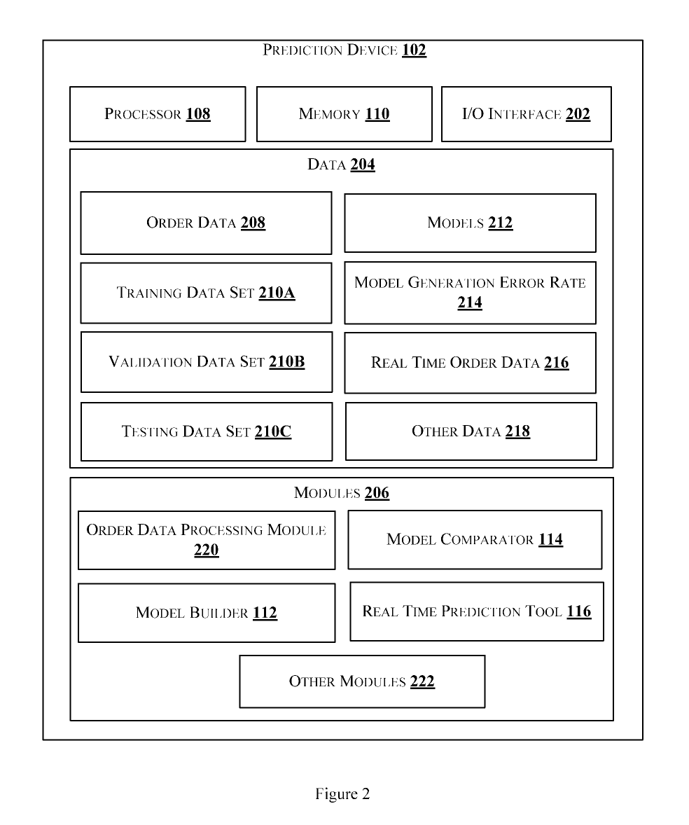

In one embodiment, the prediction device 102 comprises a processor 108, a memory 110, a model builder 112, a model comparator 114 and a real time prediction tool 116. The prediction device 102 is configured to determine a real time prediction model for real time prediction of timely delivery of telecom services to end customers. The prediction device is one of the possible variations of the prediction device 102 described in greater details below with reference to FIG. 2. In one implementation, the exemplary prediction device 102, as shown in FIG. 2, includes the central processing unit (“CPU” or “processor”) 108, the memory 110 and an I/O interface 202.

Processor 108 may comprise at least one data processor for executing program components for executing user- or system-generated requests. The processor may include specialized processing units such as integrated system (bus) controllers, memory management control units, floating point units, graphics processing units, digital signal processing units, etc. The processor 108 may include a microprocessor, such as AMD Athlon, Duron or Opteron, ARM's application, embedded or secure processors, IBM PowerPC, Intel's Core, Itanium, Xeon, Celeron or other line of processors, etc. The processor 108 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 108 may be disposed in communication with one or more input/output (I/O) devices via I/O interface 202. The I/O interface 202 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 202, the prediction device 102 may communicate with one or more I/O devices. For example, the input device may be an keyboard, mouse, joystick, (infrared) remote control, card reader, fax machine, dongle, microphone, touch screen, touchpad, trackball, sensor (e.g., accelerometer, light sensor, GPS, gyroscope, proximity sensor, or the like), stylus, scanner, transceiver, video device/source, visors, etc. Output device may be a printer, fax machine, video display (e.g., cathode ray tube (CRT), liquid crystal display (LCD), light-emitting diode (LED), plasma, or the like), audio speaker, etc. The I/O device is configured to receive inputs via the I/O interface 202 and transmit outputs for displaying in the I/O device via the I/O interface 202.

The memory 110 may include one or more memory devices for example, RAM, ROM, etc. coupled to the processor 108 via a storage interface. The memory 110 may store a collection of program or database components. In one implementation, the memory 110 may store data 204 and modules 206. In one example, the data 204 may include order data 208, training data sets 210A, validation data sets 210B, testing data sets 210C, models 212, model generation error rate 214, real time order data 216 and other data 218. In one embodiment, the data 204 may be stored in the memory 110 in the form of various data structures. Additionally, the aforementioned data can be organized using data models, such as relational or hierarchical data models. The other data 218 may be used to store data, including temporary data and temporary files, generated by the modules 206 for performing the various functions of the prediction device 102.

The modules 206 may include, for example, an order data processing (ODP) module 220, the model builder 112, the model comparator 114 and the real time prediction tool 116. The modules 206 may also comprise other modules 222 to perform various miscellaneous functionalities of the prediction device 102. It will be appreciated that such aforementioned modules may be represented as a single module or a combination of different modules.

In one embodiment, the prediction device 102 receives order data 208 associated with customer orders of telecom service products from the TSP repository 104 via the network 106. Order data 208 may include consolidated order data collected in the past for a predetermined time period say for example 2 or 3 months. Order data 208 comprises data corresponding to one or more first variables associated with the plurality of telecom service orders. One or more first variables may include for example, delivery bucket, order type, straight through product (STP)/non-straight through product (NSTP), product code, location, order entry, target completion date (TCD), order closed date, bundled/non bundled product and so on. The ODP module 220 of the prediction device 102 receives the order data 208 from the TSP repository 104 and processes the received order data to generate a processed order data.

In one implementation, the ODP module 220 identifies one or more second variables required for predicting the real time delivery of telecom service orders, for example, the one or more second variables may include delivery status of the telecom service orders. Upon identifying the one or more second variables, the ODP module 220 derives the data corresponding to the one or more second variables using the data corresponding to the first variables. For example, the ODP module 220 derives the delivery status of each telecom service order based on the data corresponding to the first variables like target completion date (TCD) and order closed date. If the order closed date is determined to be equal or lesser than the target completion date, then the delivery status of that telecom service order is determined as “On Time” else, the delivery status is determined as “Late Delivery”. Further, the ODP module 220 also determines one or more missing data corresponding to the first variables. For example, the ODP module 220 determines missing data by computing mean of continuous data or mode of discrete data. The ODP module 220 adds the derived data corresponding to the one or more second variables and the missing data in the received order data 208 thereby generating a processed order data in entirety.

Upon processing the order data 208, the ODP module 220 partitions the processed order data into one or more data sets for example, a training data set 210A, a validation data set 210B and a testing data set 210C. Each data set 210A, 210B, 210C comprises at least a subset of data corresponding to the first and second variables of the processed order data. In one example, the processed order data is partitioned in the ratio of 50:30:20 such that the training data set 210A comprise 50%, the validation data set 210B comprises 30% and the testing data set 210C comprises 20% of the processed order data.

The model builder 112 generates a plurality of models 212 using the one or more data sets of the processed order data. In one embodiment, the model builder 112 generates a plurality of models 212 based on the training data set 210A. The model builder 112 identifies one or more first and second variables that influences the timely delivery of the telecom service products from the training data set 210A and generates each model upon identification. In one example, the model builder 112 identifies one or more third, fourth, fifth and sixth variables from the training data set 210A and respectively generate at least a decision tree model, a prediction tree model, a regression model and a neural network model.

For example, the one or more third variables identified for generating the decision tree model may include order type, STP/NSTP, and delivery bucket having value greater than 8.5 days; the one or more fourth variables identified for generating the prediction tree model may include order type, STP/NSTP, and location. Further, one or more fifth variables identified for generating the regression model may include order type, STP/NSTP, and delivery bucket having value greater than 8.5 days. Furthermore, one or more sixth variables identified for generating the neural network model may include bundled/non bundled, STP/NSTP, and location. Based on the one or more identified third, fourth, and fifth variables, the model builder 112 respectively generates a decision tree model, a prediction tree model and a regression model.

The model builder 112 also generates a neural network model based on the one or more sixth variables thus identified. In one implementation, the model builder 112 identifies the one or more sixth variables from among the first and second variables that are inconsistent with the remaining of the first and second variables. For example, the model builder 112 identifies the one or more inconsistent sixth variables or outliers using techniques like Log transformation and eliminates the one or more sixth variables from the training data set 210A to generate a consistent training data set comprising one or more seventh variables. The model builder 112 then generates a neural network model using the one or more seventh variables of the consistent training data set. Further, the model builder 112 determines the validity of the generated plurality of models 212 using the data corresponding to the first and second variables in the validation data set 210B.

Upon determining the validity of the generated plurality of models 212, the model comparator 114 selects a model having a minimum model generation error rate among the plurality of models thus generated. Model generation error rate 214, for example may be a misclassification rate (MR) that indicates the rate of incorrectly classifying the data. In one embodiment, the model comparator 114 determines a first model generation error rate or first MR for each model generated based on the training data set 210A and further determines a second model generation error rate or second MR for each model validated based on the validation data set 210B. The model comparator 114 then compares the first model generation error rate or first MR and the second model generation error rate or second MR and determines a minimum model generation error rate or MR based on the comparison. Then, the model comparator 114 selects the model having the minimum model generation error rate or MR for real time prediction. In one example, the model comparator 114 selects the decision tree model having minimum model generation error rate or MR and enables the real time prediction tool to determine the real time delivery of telecom products using the selected decision tree model.

The real time prediction tool 116 determines the real time timely delivery of the telecom product on the real time order data 216. In one embodiment, the real time prediction tool 116 feeds the one or more third variables of the selected decision tree model into a workflow tool that super imposes the one or more third variables of the selected decision tree model on the real time order data 216 and determines as to whether the telecom order is timely delivered or not. For example, the real time prediction tool 116 determines as to whether the real time order data 216 satisfies the criteria specified by the third variables that include order type, STP/NSTP, and delivery bucket having value greater than 8.5 days of the selected decision tree model. If the real time prediction tool 116 determines that the real time order data 216 is not satisfying the criteria specified by the third variables of the selected decision tree model, then the real time order is predicted as “Order not meeting the target customer delivery date” or predicted as “Late Delivery”.

By way of predicting the real time status of delivery of telecom products, the orders that are likely to fail from meeting the delivery timelines are identified and are managed by respective recovery team to ensure that the end customers receive on time delivery of telecom products. By improving the on time delivery, the end customer experience is also improved, thereby increasing the revenue realization for the Telecom service providers.

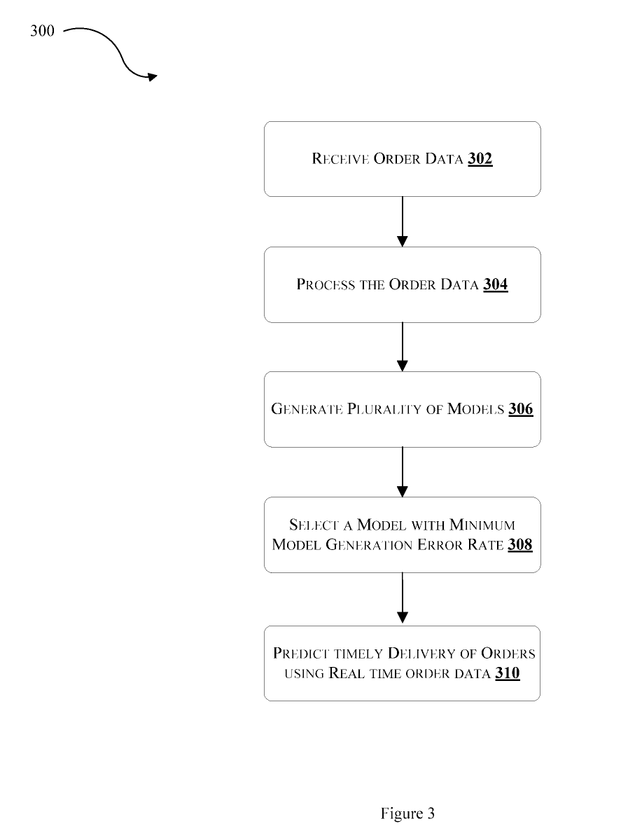

FIG. 3 illustrates a flowchart of a method of predicting timely delivery of telecom service orders in real time in accordance with some embodiments of the present disclosure.

As illustrated in FIG. 3, the method 300 comprises one or more blocks implemented by the processor 108 for predicting timely delivery of telecom service orders in real time. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 302, receive order data. In one embodiment, the prediction device 102 receives order data 208 associated with customer orders of telecom service products from the TSP repository 104 via the network 106. As illustrated in Table 1 below, the order data 208 received by the prediction device 102 comprises data corresponding one or more first variables like segment, delivery bucket, status, straight through product (STP)/non-straight through product (NSTP), line type, order type, product code, location, code, order entry, target completion date (TCD), order closed date, dealer/AE, state, stage 60, stage 20 and bundled/non bundled and so on. The ODP module 220 of the prediction device 102 receives the order data 208 from the TSP repository 104 and processes the received order data to generate a processed order data.

At block 304, process the order data. In one embodiment, the ODP module 220 identifies the one or more second variables required for predicting the real time delivery of telecom service orders, for example, delivery status of the telecom service orders. The ODP module 220 derives the data corresponding to the delivery status of each telecom service order based on the data corresponding to the first variables like target completion date (TCD) and order closed date. If the order closed date is determined to be equal or lesser than the target completion date, then the delivery status of that telecom service order is determined as “On Time” else, the delivery status is determined as “Late Delivery”.

Further, the ODP module 220 also determines the missing data by computing mean of continuous data or mode of discrete data. The ODP module 220 adds the derived data corresponding to the one or more second variables and the missing data in the received order data 208 thereby generating a processed order data in entirety. As illustrated in Table 2, the processed order data comprises the data corresponding to the second variable for example, delivery status and the missing data. Upon processing the order data 208, the ODP module 220 partitions the processed order data into the training data set 210A, the validation data set 210B and the testing data set 210C. Each data set 210A, 210B, 210C comprises at least a subset of data corresponding to the first and second variables of the processed order data.

TABLE 1

| | Delivery | | STP/ | Line | Order | Product | | | Order | | Order | | Stage | Stage | Bundled/ |
|---|---|---|---|---|---|---|---|---|---|---|---|---|---|---|---|
| Segment | Bucket | Status | NSTP | Type | Type | Code | Location | Code | Entry | TCD | Closed | State | 60 | 20 | Unbundled |
| 1 | 5 days | 90 | STP | ELB | ERF | TBBNEW | BLV | BVV | On | 02- | 02- | QLD | Met | Met | Bundled |
| | | | | | | | | | Time | Apr | Apr | | | | |
| 1 | 5 days | 90 | STP | ELB | CAN | TBBNEW | ST | BNV | On | 28- | 28- | VIC | Met | Met | Bundled |
| | | | | | | | | | Time | Dec | Dec | | | | |
| 1 | >8.5 | 90 | STP | ELB | NEW | TBBNEW | ST | KNE | On | 18- | 19- | NSW | Met | Met | Bundled |
| | days | | | | | | | | Time | Jul | Jul | | | | |
| 1 | 5 days | 90 | STP | ELB | MOD | ECCND | ST | BNT | On | 14- | 14- | SA | Met | Met | Bundled |
| | | | | | | | | | Time | Jul | Jul | | | | |
| 1 | 5 days | 90 | STP | ELB | CAN | TBBREC | LA | BVB | On | 17- | 17- | NSW | Met | Met | Bundled |
| | | | | | | | | | Time | Jul | Jul | | | | |
| 2 | 5 days | 90 | STP | ELB | CAN | TBBREC | CRS | BNV | On | 28- | 28- | NSW | Met | Met | Bundled |
| | | | | | | | | | Time | Dec | Dec | | | | |
| 1 | >8.5 | 90 | STP | ELB | NEW | BBOSPI | | KVE | On | 17- | 17- | NSW | Met | Met | Bundled |
| | days | | | | | | | | Time | Jul | Jul | | | | |
| 1 | 5 days | 90 | STP | ELB | CAN | TBBNEW | AVE | CAV | On | 10- | 10- | NSW | Met | Met | Bundled |
| | | | | | | | | | Time | Jul | Jul | | | | |
| 1 | 5 days | 90 | STP | ELB | CAN | SLPN | WAY | CYT | On | 17- | 17- | NSW | Met | Met | Bundled |
| | | | | | | | | | Time | Jul | Jul | | | | |
| 1 | 5 days | 90 | STP | ELB | NEW | TBBNEW | RD | KVD | On | 21- | 21- | QLD | Met | Met | Bundled |
| | | | | | | | | | Time | Jul | Jul | | | | |
| 1 | >8.5 | 90 | STP | ELB | CAN | TBBNEW | AVE | CYC | Late | 16- | 16- | VIC | Met | Met | Bundled |
| | days | | | | | | | | | Jul | Jul | | | | |
| 2 | 5 days | 90 | NSTP | ELB | NEW | TBBNEW | | BNC | On | 17- | 17- | VIC | Met | Not | Bundled |
| | | | | | | | | | Time | Jul | Jul | | | | |
| 1 | 5 days | 90 | STP | ELB | CAN | BDCONN | RD | BNT | On | 15- | 15- | VIC | Met | Met | Bundled |
| | | | | | | | | | Time | Jul | Jul | | | | |
| 1 | 5 days | 90 | STP | ELB | NEW | TBBNEW | | KVD | On | 16- | 16- | VIC | Met | Met | Bundled |
| | | | | | | | | | Time | Jul | Jul | | | | |
| 1 | 5 days | 90 | STP | ELB | NEW | TBBNEW | | KVD | On | 15- | 17- | VIC | Met | Met | Unbundled |
| | | | | | | | | | Time | Jul | Jul | | | | |
| 1 | 5 days | 90 | STP | ELB | NEW | 2ABJB0 | ST | KVD | On | 14- | 14- | VIC | Met | Met | Bundled |
| | | | | | | | | | Time | Jul | Jul | | | | |
| 1 | >8.5 | 90 | STP | ELB | NEW | TBBNEW | ST | CBV | On | 16- | 16- | VIC | Met | Met | Bundled |
| | days | | | | | | | | Time | Jul | Jul | | | | |
| 1 | 5 days | 90 | STP | ELB | NEW | TBBNEW | ST | IIG | On | 18- | 18- | VIC | Met | Met | Bundled |
| | | | | | | | | | Time | Jul | Jul | | | | |
| 1 | 5 days | 90 | STP | ELB | NEW | TBBNEW | | CBB | On | 14- | 14- | SA | Met | Met | Bundled |
| | | | | | | | | | Time | Jul | Jul | | | | |
| 1 | 5 days | 90 | STP | ELB | CAN | TBBNEW | ST | BVV | On | 16- | 16- | SA | Met | Met | Bundled |
| | | | | | | | | | Time | Jul | Jul | | | | |
| 1 | 5 days | 90 | NSTP | ELB | NEW | TBBNEW | | CMT | On | 17- | 17- | VIC | Met | Not | Bundled |
| | | | | | | | | | Time | Jul | Jul | | | Met | |
| 1 | >8.5 | 90 | STP | TFSC | MOD | TBBNEW | ST | CYM | On | 15- | 15- | NSW | Met | Met | Bundled |
| | days | | | | | | | | Time | Jul | Jul | | | | |
| 1 | 5 days | 90 | STP | ELB | MOD | TBBNEW | CL | BVM | Late | 15- | 15- | NSW | Met | Met | Bundled |
| | | | | | | | | | | Jul | Jul | | | | |
| 1 | >8.5 | 90 | STP | ELB | NEW | DSLUID | | CYV | On | 14- | 14- | NSW | Met | Met | Bundled |
| | days | | | | | | | | Time | Jul | Jul | | | | |
| 1 | 5 days | 90 | STP | ELB | MOD | 8ABSG0 | ST | CMM | On | 16- | 16- | QLD | Met | Met | Bundled |
| | | | | | | | | | Time | Jul | Jul | | | | |

TABLE 2

| | Delivery | | STP/ | Line | Order | Product | | | Order |
|---|---|---|---|---|---|---|---|---|---|
| Segment | Bucket | Status | NSTP | Type | Type | Code | Location | Code | Entry |
| 1 | 5 days | 90 | STP | ELB | ERF | TBBNEW | BLV | BVV | On |
| | | | | | | | | | Time |
| 1 | 5 days | 90 | STP | ELB | CAN | TBBNEW | ST | BNV | On |
| | | | | | | | | | Time |
| 1 | >8.5 | 90 | STP | ELB | NEW | TBBNEW | ST | KNE | On |
| | days | | | | | | | | Time |
| 1 | 5 days | 90 | STP | ELB | MOD | ECCND | ST | BNT | On |
| | | | | | | | | | Time |
| 1 | 5 days | 90 | STP | ELB | CAN | TBBREC | LA | BVB | On |
| | | | | | | | | | Time |
| 2 | 5 days | 90 | STP | ELB | CAN | TBBREC | CRS | BNV | On |
| | | | | | | | | | Time |
| 1 | >8.5 | 90 | STP | ELB | NEW | BBOSPI | | KVE | On |
| | days | | | | | | | | Time |
| 1 | 5 days | 90 | STP | ELB | CAN | TBBNEW | AVE | CAV | On |
| | | | | | | | | | Time |
| 1 | 5 days | 90 | STP | ELB | CAN | SLPN | WAY | CYT | On |
| | | | | | | | | | Time |
| 1 | 5 days | 90 | STP | ELB | NEW | TBBNEW | RD | KVD | On |
| | | | | | | | | | Time |
| 1 | >8.5 | 90 | STP | ELB | CAN | TBBNEW | AVE | CYC | Late |
| | days | | | | | | | | |
| 2 | 5 days | 90 | NSTP | ELB | NEW | TBBNEW | | BNC | On |
| | | | | | | | | | Time |
| 1 | 5 days | 90 | STP | ELB | CAN | BDCONN | RD | BNT | On |
| | | | | | | | | | Time |
| 1 | 5 days | 90 | STP | ELB | NEW | TBBNEW | | KVD | On |
| | | | | | | | | | Time |
| 1 | 5 days | 90 | STP | ELB | NEW | TBBNEW | | KVD | On |
| | | | | | | | | | Time |
| 1 | 5 days | 90 | STP | ELB | NEW | 2ABJB0 | ST | KVD | On |
| | | | | | | | | | Time |
| 1 | >8.5 | 90 | STP | ELB | NEW | TBBNEW | ST | CBV | On |
| | days | | | | | | | | Time |
| 1 | 5 days | 90 | STP | ELB | NEW | TBBNEW | ST | IIG | On |
| | | | | | | | | | Time |
| 1 | 5 days | 90 | STP | ELB | NEW | TBBNEW | | CBB | On |
| | | | | | | | | | Time |
| 1 | 5 days | 90 | STP | ELB | CAN | TBBNEW | ST | BVV | On |
| | | | | | | | | | Time |
| 1 | 5 days | 90 | NSTP | ELB | NEW | TBBNEW | | CMT | On |
| | | | | | | | | | Time |
| 1 | >8.5 | 90 | STP | TFSC | MOD | TBBNEW | ST | CYM | On |
| | days | | | | | | | | Time |
| 1 | 5 days | 90 | STP | ELB | MOD | TBBNEW | CL | BVM | Late |
| 1 | >8.5 | 90 | STP | ELB | NEW | DSLUID | | CYV | On |
| | days | | | | | | | | Time |
| 1 | 5 days | 90 | STP | ELB | MOD | 8ABSG0 | ST | CMM | On |
| | | | | | | | | | Time |

| | Delivery | | Order | | Stage | Stage | Bundled/ | Delivery |
|---|---|---|---|---|---|---|---|---|
| Segment | Bucket | TCD | Closed | State | 60 | 20 | Unbundled | Status |
| 1 | 5 days | 02- | 02- | QLD | Met | Met | Bundled | On Time |
| | | Apr | Apr | | | | | |
| 1 | 5 days | 28- | 28- | VIC | Met | Met | Bundled | On Time |
| | | Dec | Dec | | | | | |
| 1 | >8.5 | 18- | 19- | NSW | Met | Met | Bundled | Late |
| | days | Jul | Jul | | | | | Delivery |
| 1 | 5 days | 14- | 14- | SA | Met | Met | Bundled | On Time |
| | | Jul | Jul | | | | | |
| 1 | 5 days | 17- | 17- | NSW | Met | Met | Bundled | On Time |
| | | Jul | Jul | | | | | |
| 2 | 5 days | 28- | 28- | NSW | Met | Met | Bundled | On Time |
| | | Dec | Dec | | | | | |
| 1 | >8.5 | 17- | 17- | NSW | Met | Met | Bundled | On Time |
| | days | Jul | Jul | | | | | |
| 1 | 5 days | 10- | 10- | NSW | Met | Met | Bundled | On Time |
| | | Jul | Jul | | | | | |
| 1 | 5 days | 17- | 17- | NSW | Met | Met | Bundled | On Time |
| | | Jul | Jul | | | | | |
| 1 | 5 days | 21- | 21- | QLD | Met | Met | Bundled | On Time |
| | | Jul | Jul | | | | | |
| 1 | >8.5 | 16- | 16- | VIC | Met | Met | Bundled | On Time |
| | days | Jul | Jul | | | | | |
| 2 | 5 days | 17- | 17- | VIC | Met | Not | Bundled | Late |
| | | Jul | Jul | | | Met | | Delivery |
| 1 | 5 days | 15- | 15- | VIC | Met | Met | Bundled | On Time |
| | | Jul | Jul | | | | | |
| 1 | 5 days | 16- | 16- | VIC | Met | Met | Bundled | On Time |
| | | Jul | Jul | | | | | |
| 1 | 5 days | 15- | 17- | VIC | Met | Met | Unbundled | On Time |
| | | Jul | Jul | | | | | |
| 1 | 5 days | 14- | 14- | VIC | Met | Met | Bundled | On Time |
| | | Jul | Jul | | | | | |
| 1 | >8.5 | 16- | 16- | VIC | Met | Met | Bundled | On Time |
| | days | Jul | Jul | | | | | |
| 1 | 5 days | 18- | 18- | VIC | Met | Met | Bundled | On Time |
| | | Jul | Jul | | | | | |
| 1 | 5 days | 14- | 14- | SA | Met | Met | Bundled | On Time |
| | | Jul | Jul | | | | | |
| 1 | 5 days | 16- | 16- | SA | Met | Met | Bundled | On Time |
| | | Jul | Jul | | | | | |
| 1 | 5 days | 17- | 17- | VIC | Met | Not | Bundled | On Time |
| | | Jul | Jul | | | Met | | |
| 1 | >8.5 | 15- | 15- | NSW | Met | Met | Bundled | On Time |
| | days | Jul | Jul | | | | | |
| 1 | 5 days | 15- | 15- | NSW | Met | Met | Bundled | On Time |
| | | Jul | Jul | | | | | |
| 1 | >8.5 | 14- | 14- | NSW | Met | Met | Bundled | On Time |
| | days | Jul | Jul | | | | | |
| 1 | 5 days | 16- | 16- | QLD | Met | Met | Bundled | On Time |
| | | Jul | Jul | | | | | |

At block 306, generate a plurality of models. In one embodiment, the model builder 112 generates a plurality of models 212 using the one or more data sets of the processed order data. In one embodiment, the model builder 112 generates a plurality of models 212 based on the training data set 210A. The model builder 112 identifies one or more first and second variables that influences the timely delivery of the telecom service products from the training data set 210A and generates each model upon identification. In one example, the model builder 112 identifies the one or more third, fourth, fifth and sixth variables from the training data set 210A and respectively generate at least a decision tree model, a prediction tree model, a regression model and a neural network model.

For example, the one or more third variables identified for generating the decision tree model may include order type, STP/NSTP, and delivery bucket having value greater than 8.5 days; the one or more fourth variables identified for generating the prediction tree model may include order type, STP/NSTP, and location. Further, one or more fifth variables identified for generating the regression model may include order type, STP/NSTP, and delivery bucket having value greater than 8.5 days. Furthermore, one or more sixth variables identified for generating the neural network model may include bundled/non bundled, STP/NSTP, and location. Based on the one or more identified third, fourth, and fifth variables, the model builder 112 respectively generates a decision tree model, a prediction tree model and a regression model.

The model builder 112 also generates a neural network model based on the one or more sixth variables thus identified. In one implementation, the model builder 112 identifies the one or more sixth variables from among the first and second variables that are inconsistent with the remaining of the first and second variables. For example, the model builder 112 identifies the one or more inconsistent sixth variables or outliers using techniques like Log transformation and eliminates the one or more sixth variables from the training data set 210A to generate a consistent training data set comprising one or more seventh variables. The model builder 112 then generates a neural network model using the one or more seventh variables of the consistent training data set. Further, the model builder 112 determines the validity of the generated plurality of models 212 using the data corresponding to the first and second variables in the validation data set 210B.

Upon determining the validity of the generated plurality of models 212, the model comparator 114 selects a model having a minimum model generation error rate among the plurality of models thus generated.

At block 308, select a model with minimum model generation error rate. In one implementation, the model comparator 114 selects a model having a minimum model generation error rate among the plurality of models thus generated. Model generation error rate 214, for example may be a misclassification rate (MR) that indicates the rate of incorrectly classifying the data. In one embodiment, the model comparator 114 determines a first model generation error rate or first MR for each model generated based on the training data set 210A and further determines a second model generation error rate or second MR for each model validated based on the validation data set 210B. The model comparator 114 then compares the first model generation error rate or first MR and the second model generation error rate or second MR and determines a minimum model generation error rate or MR based on the comparison. Then, the model comparator 114 selects the model having the minimum model generation error rate or MR for real time prediction. In one example, the model comparator 114 selects the decision tree model having minimum model generation error rate or MR and enables the real time prediction tool to determine the real time delivery of telecom products using the selected decision tree model.

At block 310, predict timely delivery of orders using real time order data. In one embodiment, the real time prediction tool 116 determines the real time timely delivery of the telecom product on the real time order data 216 as illustrated in Table 3 below. In one embodiment, the real time prediction tool 116 super imposes the one or more third variables of the selected decision tree model on the real time order data 216 and determines as to whether the telecom order is timely delivered or not. For example, the real time prediction tool 116 determines as to whether the real time order data 216 satisfies the criteria specified by the third variables including order type, STP/NSTP, and delivery bucket having value greater than 8.5 days of the selected decision tree model. If the real time prediction tool 116 determines that the real time order data 216 is not satisfying the criteria specified by the third variables of the selected decision tree model, then the real time order is predicted as “Order not meeting the target customer delivery date” as illustrated in Table 3.

TABLE 3

| | | Type of | | | | | | | | |
|---|---|---|---|---|---|---|---|---|---|---|
| | | Phone | Order | Ownership | | STP/ | Delivery | Held | Order | |
| Axis No | Segment | Line | Type | Code | State | NSTP | Bucket | Days | Closed | Prediction |
| 3754735 | 1 | TFSC | MOD | CYM | WA | STP | 5 days | No | 15-07- | |
| | | | | | | | | Held | 2014 | |
| 3754742 | 1 | ELB | MOD | BVM | VIC | STP | >8.5 | No | 15-07- | |
| | | | | | | | days | Held | 2014 | |
| 3756956 | 1 | ELB | NEW | BNV | SA | NSTP | >8.5 | <less | 16-07- | Order |
| | | | | | | | days | than 5 | 2014 | not |
| | | | | | | | | days | | meeting |
| | | | | | | | | | | the |
| | | | | | | | | | | delivery |
| | | | | | | | | | | date |
| 3757024 | 1 | ELB | MOD | BQV | SA | STP | 5 days | No | 16-07- | |
| | | | | | | | | Held | 2014 | |
| 3758339 | 1 | ELB | MOD | KVD | VIC | STP | 5 days | No | 16-07- | |
| | | | | | | | | Held | 2014 | |
| 3759813 | 1 | ELB | MOD | CYP | WA | STP | 5 days | No | 15-07- | |
| | | | | | | | | Held | 2014 | |
| 3759885 | 1 | ELB | MOD | BWV | WA | STP | 5 days | No | 18-07- | |
| | | | | | | | | Held | 2014 | |
| 3761550 | 1 | ELB | MOD | CYV | WA | STP | 5 days | No | 17-07- | |
| | | | | | | | | Held | 2014 | |
| 3766341 | 1 | ELB | MOD | KVD | VIC | STP | 5 days | No | 18-07- | |
| | | | | | | | | Held | 2014 | |
| 3766349 | 1 | ELB | MOD | CYM | WA | STP | >8.5 | No | 15-07- | |
| | | | | | | | days | Held | 2014 | |
| 3766352 | 1 | ELB | MOD | BNT | NSW | STP | 5 days | No | 15-07- | |
| | | | | | | | | Held | 2014 | |
| 3766356 | 1 | ELB | NEW | CYB | SA | NSTP | >8.5 | No | 17-07- | Order |
| | | | | | | | days | Held | 2014 | not |
| | | | | | | | | | | meeting |
| | | | | | | | | | | the |
| | | | | | | | | | | delivery |
| | | | | | | | | | | date |

By way of predicting the real time status of delivery of telecom products, the orders that are likely to fail from meeting the delivery timelines are identified and are managed by respective recovery team to ensure that the end customers receive on time delivery of telecom products. By improving the on time delivery, the end customer experience is also improved, thereby increasing the revenue realization for the Telecom service providers.

As described above, the modules 206, amongst other things, include routines, programs, objects, components, and data structures, which perform particular tasks or implement particular abstract data types. The modules 206 may also be implemented as, signal processor(s), state machine(s), logic circuitries, and/or any other device or component that manipulate signals based on operational instructions. Further, the modules 206 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of predicting in real time timely delivery of telecom services to a customer, the method comprising:
receiving, by a processor of a prediction device, order data collected for a predetermined time period from a telecom service provider repository, the order data comprising data corresponding to one or more first variables associated with a plurality of telecom service orders;
processing, by the processor, the received order data to generate a processed order data comprising one or more second variables and one or more missing data corresponding to the first variables derived from the received order data;
generating, by the processor, a plurality of models based on one or more first and second variables identified from the processed order data;
selecting, by the processor, a model having a minimum model generation error rate among the plurality of models thus generated; and
predicting, by the processor, the timely delivery of the telecom services based on the selected model and real time order data.

2. The method as claimed in claim 1, wherein processing the received order data comprising the steps of:
identifying the one or more second variables required for predicting the real time delivery;
deriving data corresponding to the one or more second variables based on the data corresponding to the first variables; and
determining the one or more missing data of the first variables and adding the determined missing data corresponding to the first variables in the order data.

3. The method as claimed in claim 1, wherein upon processing the received order data, the method comprising the step of partitioning the processed order data into at least a training data set, a validation data set and a testing data set, each data set comprising at least a subset of data corresponding to the first and second variables of the processed order data.

4. The method as claimed in claim 3, wherein generating the plurality of models comprising the steps of:
identifying one or more third, fourth, fifth and sixth variables respectively from the training data set;
generating at least a decision tree model, a prediction tree model, a regression model and a neural network model respectively based on the identified third, fourth, fifth and sixth variables of the training data set; and
determining the validity of the generated plurality of models based on the validation data set.

5. The method as claimed in claim 4, wherein generating the neural network model comprising the steps of:
identifying the one or more sixth variables from the training data set that are inconsistent with the remaining of the first and second variables in the training data set;
eliminating the one or more identified sixth variables from the training data set to generate a consistent training data set comprising one or more seventh variables; and
generating the neural network model based on the one or more seventh variables of the consistent training set.

6. The method as claimed in claim 3, wherein the step of selecting the model among the plurality of models comprising:
determining a first model generation error rate associated with generation of the plurality of models based on the training data set;
determining a second model generation error rate associated with generation of the plurality of models based on the validation data set;
comparing the first model generation error rate and the second model generation error rate thus determined;
determining a minimum model generation error rate based on the comparison; and
selecting the model having the minimum model generation error rate thus determined.

7. A prediction device for predicting in real time timely delivery of telecom services to a customer, comprising:
a processor;
a telecom service provider repository coupled with the processor and configured to store order data associated with a plurality of telecom service orders; and
a memory disposed in communication with the processor and storing processor-executable instructions, the instructions comprising instructions to:
receive the order data collected for a predetermined time period from the telecom service provider repository;
process the received order data to generate a processed order data comprising one or more second variables and one or more missing data corresponding to the first variables derived from the received order data;
generate a plurality of models based on one or more first and second variables identified from the processed order data;
select a model having a minimum model generation error rate among the plurality of models thus generated; and
predict the timely delivery of the telecom services based on the selected model and real time order data.

8. The device as claimed in claim 7, wherein the processor is configured to process the received order data by performing the steps of:
identifying the one or more second variables required for predicting the real time delivery;
deriving data corresponding to the one or more second variables based on the data corresponding to the first variables; and
determining the one or more missing data of the first variables and adding the determined missing data corresponding to the first variables in the received order data.

9. The device as claimed in claim 7, wherein upon processing the received order data, the processor is configured to partition the processed order data into at least a training data set, a validation data set and a testing data set, each data set comprising at least a subset of data corresponding to the first and second variables of the processed order data.

10. The device as claimed in claim 9, wherein the processor is configured to generate the plurality of models by performing the steps of:
identifying one or more third, fourth, fifth and sixth variables respectively from the training data set;
generating at least a decision tree model, a prediction tree model, a regression model and a neural network model respectively based on the identified third, fourth, fifth and sixth variables of the training data set; and
determining the validity of the generated plurality of models based on the validation data set.

11. The device as claimed in claim 10, wherein the processor is configured to generate the neural network model by the steps of:
identifying the one or more sixth variables from the training data set that are inconsistent with the remaining of the third variables in the training data set;
eliminating the one or more identified sixth variables from the training data set to generate a consistent training data set comprising one or more seventh variables; and
generating the neural network model based on the one or more seventh variables of the consistent training set.

12. The device as claimed in claim 9, wherein the processor is configured to select the model among the plurality of models by performing the steps of:
determining a first model generation error rate associated with generation of the plurality of models based on the training data set;
determining a second model generation error rate associated with generation of the plurality of models based on the validation data set;
comparing the first model generation error rate and the second model generation error rate thus determined;
determining a minimum model generation error rate based on the comparison; and
selecting the model having the minimum model generation error rate thus determined.

13. A non-transitory computer readable medium including instructions stored thereon that when processed by at least one processor cause a system to perform acts of:
receiving order data related to a predetermined time period comprising one or more first variables associated with a plurality of telecom service orders;
processing the received order data to generate a processed order data comprising one or more second variables and one or more missing data corresponding to the first variables derived from the received order data;
generating a plurality of models based on one or more first and second variables identified from the processed order data;
selecting a model having a minimum model generation error rate among the plurality of models thus generated; and
predicting the timely delivery of the telecom services based on the selected model and real time order data.
